(19) United States
(12) Patent Application Publication
(10) Pub. No.: US 2024/0071644 A1
(43) Pub. Date: Feb. 29, 2024

(54) Low-Profile X-Ray Scanning Source with Ring Collimator

(71) Applicant: Viken Detection Corporation, Burlington, MA (US)

(72) Inventor: Peter J. Rothschild, Newton, MA (US)

(21) Appl. No.: 18/259,662

(22) PCT Filed: Jan. 7, 2022
(86) PCT No.: PCT/US2022/070099

§ 371 Date: Jun. 28, 2023

Related U.S. Application Data
(60) Provisional application No. 63/135,150, filed on Jan. 8, 2021.

(51) Int. Cl. G21K 1/04

(52) U.S. Cl. CPC G21K 1/043

(57) ABSTRACT

An x-ray beam generator includes an x-ray source and a collimation ring to generate a sweeping x-ray beam. The x-ray source emits a beam of x-ray radiation through an opening in an enclosure. The collimation ring defines one or more apertures, and encompasses the enclosure at the opening and has an outer diameter less than 150% of an outer diameter of the enclosure at the opening. A support bearing is coupled to the collimation ring and enables the collimation ring to rotate about the x-ray source. A drive system rotates the collimation ring about the x-ray source during activation of the x-ray source to form the sweeping x-ray beam via the one or more apertures.

### RELATED APPLICATION

This application claims the benefit of U.S. Provisional Application No. 63/135,150, filed on Jan. 8, 2021. The entire teachings of the above application are incorporated herein by reference.

### BACKGROUND

X-ray backscatter imaging has been used for detecting concealed contraband, such as drugs, explosives, and weapons, since the late 1980s. Unlike traditional transmission x-ray imaging that creates images by detecting the x-rays penetrating through a target object, backscatter imaging uses reflected or scattered x-rays to create the image.

An example disk chopper wheel that creates the scanning pencil beam used in a backscatter x-ray imaging instrument may include a tungsten outer disk, typically with an aluminum inner hub, with the tungsten outer disk defining one or more radial slits. A fan beam of x-rays can be incident on the disk chopper wheel, illuminating a strip on one side of the disk. Only one of the radial slits may be illuminated at any given time, allowing a scanning pencil beam of x-rays to pass though the slit.

A scanning pencil beam used for x-ray backscatter imaging can also be used to create a transmission image with a transmission detector present.

### SUMMARY

Example embodiments include an apparatus for generating a sweeping x-ray beam. The apparatus may include an x-ray source configured to emit a beam of x-ray radiation through an opening in an enclosure. A collimation ring may define at least one aperture, and may encompass the enclosure at the opening and having an outer diameter less than 150% of an outer diameter of the enclosure at the opening. A support bearing may be coupled to the collimation ring and configured to enable the collimation ring to rotate about the x-ray source. A drive system may be configured to rotate the collimation ring about the x-ray source during activation of the x-ray source to form the sweeping x-ray beam via the at least one aperture.

The support bearing may have an outer diameter less than 200% of the outer diameter of the enclosure at the opening. The drive system may include a motor configured to rotate a friction wheel coupled to a surface of the collimation ring. Alternatively, the drive system may include a gear train and/or a drive belt configured to rotate the collimation ring about the x-ray source.

An inner surface of the collimation ring is positioned fewer than 5 centimeters from an outer surface of the enclosure. A field of view of the sweeping beam of x-rays may be greater than 100 degrees, 120 degrees, or 140 degrees. The x-ray source may include an x-ray tube and a high-voltage power supply incorporated within the enclosure. A fan may be configured to air-cool the x-ray source. The x-ray source may include a unipolar or bipolar x-ray tube. The support bearing may be a deep-groove ball bearing, and may be grease-lubricated or oil-lubricated.

Further, a relocatable ramp may be configured to house the x-ray source, collimation ring, support bearing, and drive system. Alternatively, the apparatus may be configured to be installed in a trench below an environment to be illuminated by the apparatus.

In one particular embodiment, an apparatus or system for creating a sweeping beam of x-rays includes a collimation ring comprising a highly attenuating material, the collimation ring defining one or more beam-forming apertures; a supporting bearing configured to enable the collimation ring to rotate about a source of X-rays; and a fan beam of x-rays illuminating the inner surface of the collimation ring. The source of X-rays can be configured to output the fan beam of x-rays such that the fan beam can illuminate the inner surface of the collimation ring.

The field of view of the sweeping beam of x-rays can be greater than 100 degrees. The x-ray source can be a compact design incorporating the x-ray tube and high voltage power supply together in one housing.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a perspective-view schematic diagram illustrating an existing x-ray detection system using a scanning pencil beam arrangement using a rotating disk with slots.

FIGS. 2A-D are perspective-view schematic diagrams illustrating different types of prior-art chopper wheels for generating a scanning x-ray beam.

FIG. 3 illustrates an imaging system using a sweeping beam with a field of view designated by the angle θ.

FIG. 4 illustrates a self-contained x-ray source and high voltage power supply that may be implemented in example embodiments.

FIG. 5 is a schematic diagram illustrating an x-ray beam source in an example embodiment.

FIG. 6 illustrates an application of an x-ray beam source in a relocatable ramp-based undercarriage inspection system in one embodiment.

FIG. 7 illustrates an application of an x-ray beam source within the shallow trench of a non-relocatable undercarriage inspection system in one embodiment.

### DETAILED DESCRIPTION

A description of example embodiments follows.

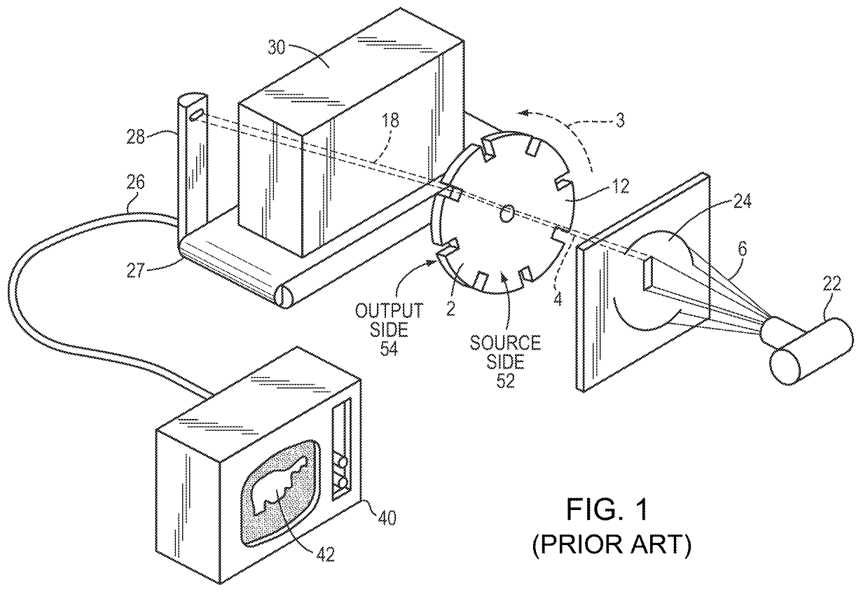

FIG. 1 is a perspective-view schematic illustration of a prior-art x-ray imaging system that uses a scanning x-ray beam, which can be used for x-ray backscatter imaging, or for x-ray transmission imaging, or both. FIG. 1 provides context for imaging with a scanning x-ray beam as a background, showing basic principles, of such imaging, such that the novel features of present embodiments may be understood more fully.

In the system of FIG. 1, a standard x-ray tube 22 generates the x-ray radiation 6 that is incident at an attenuating plate 24. The radiation is collimated into a fan beam 4 by a slot in attenuating plate 24, and the fan beam 4 is incident at a source side 52 of the disk chopper wheel 2, where the source side 52 is the side of the chopper wheel that is closest to the x-ray source 22. The fan beam is then “chopped” into a pencil beam by the rotating “chopper wheel” 2 with slits 12. The pencil beam 18 is output through an output side 54 of the disk chopper wheel (the side opposite the x-ray source 22) and scans over the target object 30 being imaged as the wheel rotates with the rotation 3. The intensity of the x-rays scattered in the backwards direction is then recorded by one or more large-area backscatter detectors (not shown) as a function of the position of the illuminating beam to form a backscatter image. In addition, the intensity of the x-rays in beam 18 transmitted through object 30 can be recorded by a transmission detector 28 to create a transmission x-ray image simultaneously.

A signal cable 26 carries scan line signals from the detector 28 to the monitor 40. By moving the object through the plane containing the scanning beam 18, either on a conveyor 27 or under its own power, a two-dimensional backscatter and/or transmission image of the object is obtained. Alternately, the object can be stationary, and the imaging system can be moved relative to the object.

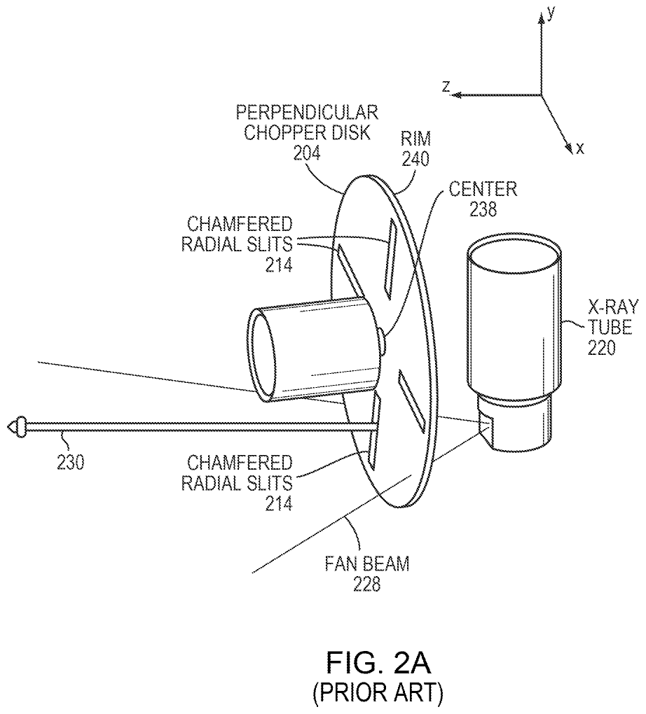

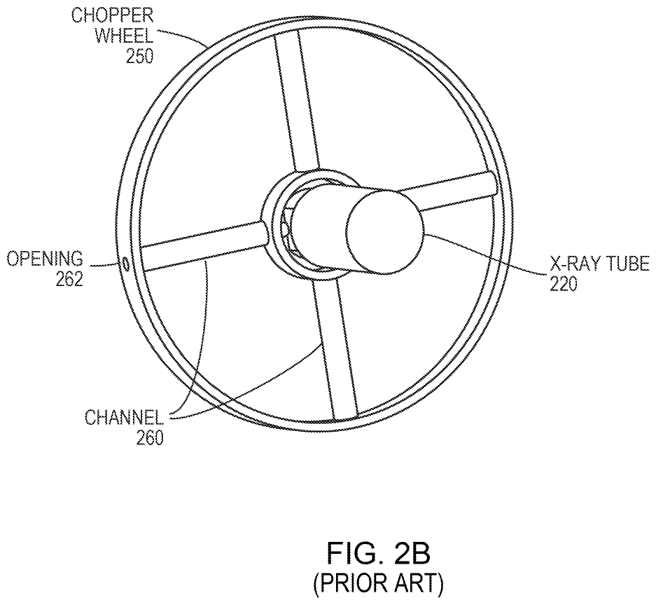

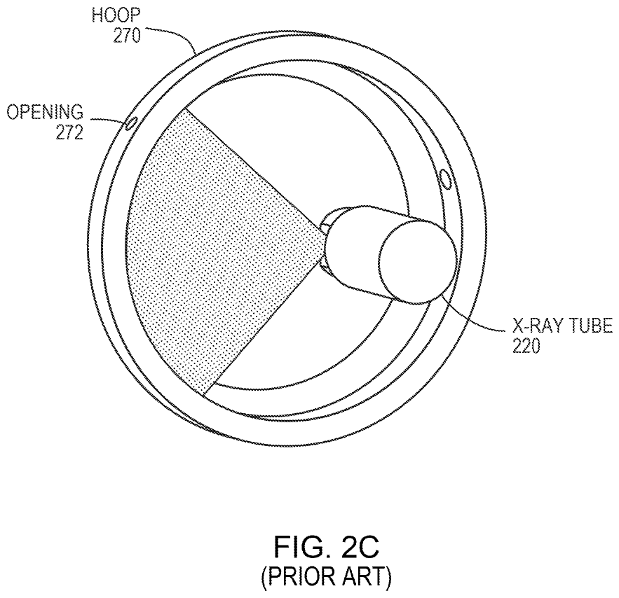

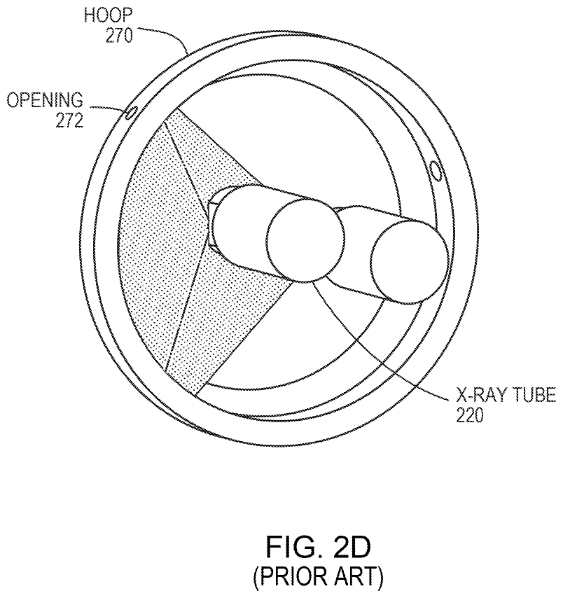

FIGS. 2A-D are perspective-view schematic diagrams illustrating different types of prior-art chopper wheels for generating a scanning x-ray beam. Existing chopper wheels typically include one of the following basic types: a disk (FIG. 2A), a wheel (FIG. 2B), a rear-offset hoop (FIG. 2C), and a forward-offset hoop (FIG. 2D).

FIG. 2A illustrates how some embodiments disclosed herein can use chopper disks oriented substantially perpendicular to x-ray fan beams. Here, an x-ray tube 220 generates a fan beam 228 of x-rays that is oriented in the X-Z plane, while a chopper disk 204 is situated, and undergoes rotation, in a disk plane that coincides with (or is parallel to) the X-Y plane. The chopper disk 204 defines radial slits 214 between the center 238 and the rim 240, and the radial slits 214 are chamfered along the long edges. The radial slits 214 are configured to pass x-ray radiation of the collimated fan beam 228. In particular, the intersection of the fan beam 228 with a radial slit 214 as the disk is rotated allows a pencil beam 230 of x-rays to pass through the disk 204. In other embodiments, the perpendicular orientation illustrated in FIG. 2A can be used for chopper disks having tapered slits, for example.

FIG. 2B illustrates a chopper wheel 250 configured to surround an emitter segment of an x-ray tube 220. The chopper wheel 250 defines four cylindrical channels 260 that extend radially from the inner surface to the outer surface of the wheel 250, terminating at respective openings 262 at the outer surface of the wheel 250. As the wheel 250 rotates, x-ray radiation emitted by the x-ray tube 220 passes through one of the channels 260 at a time, generating a sweeping pencil x-ray beam through the openings 262.

FIGS. 2C and 2D illustrate a rear-offset hoop and a forward-offset hoop, respectively. In both FIGS. 2C and 2D, a hoop 270 defines a plurality of openings 272. As the hoop 270 rotates, x-ray radiation emitted by the x-ray tube 220 passes through one of the openings 272 at a time, generating a sweeping pencil x-ray beam through the openings 272. In FIG. 2C, the x-ray tube 220 is positioned behind the center of the hoop 270 relative to the beam output, while in FIG. 2D, the x-ray tube 220 is positioned in front of the center of the hoop 270 relative to the beam output. By varying the position of source 220 relative to the center of the hoop 270, the angle over which the output beam sweeps can be varied.

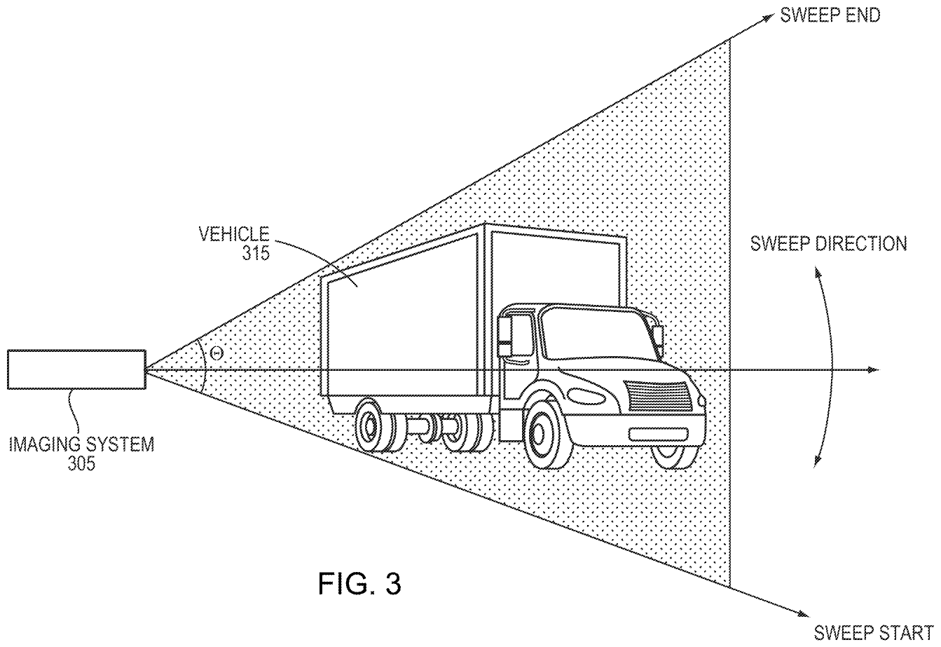

FIG. 3 illustrates an imaging system 305 configured to scan a vehicle 315. The imaging system 305 emits a sweeping pencil beam, and the angular range over which the sweeping pencil beam illuminates the object is referred to as the field of view (FoV) of the imaging system and is denoted by the angle θ in FIG. 3. As soon as the pencil beam created by an aperture in the chopper wheel leaves the FoV, the pencil beam created by the next aperture enters the FoV. This ensures that only one pencil beam of radiation is illuminating the object at any given time.

One limitation of many existing beam-forming mechanisms is that they are quite large, and the FoV is often limited to about 90 degrees. Referring to the chopper wheels shown in FIGS. 2A-D, the disk 204 in FIG. 2A is limited to about a 90° FoV, unless the x-ray source is extremely close to the disk. However, such a configuration can severely reduce the collimation distance between the chopper wheel aperture and the x-ray source focal spot, resulting in a rapidly diverging, poorly-defined beam that yields poor image resolution. The wheel 250 in FIG. 2B can at most have a 90° FoV. If configured with three spokes instead of four, it would be capable of a 120° FoV if the output fan angle of the x-ray source is at least 120° in extent. The limitation of this design, however, is that it is quite bulky and is not a low-profile design that can be positioned to image a larger object at a relatively close distance. The back-offset hoop shown in FIG. 2C, with three apertures, is also limited to about a 90° FoV.

In contrast, the forward-offset hoop 270 shown in FIG. 2D and described in detail in U.S. Pat. No. 8,861,684, is capable of a larger FoV, depending on how far the x-ray source focal spot is offset in the forward direction from the rotational center of the hoop. However, such a system also requires a relatively large space in which to operate, and, thus, cannot be implemented in applications requiring a compact or low-profile beam source.

Example embodiments, described herein, include a low-profile x-ray beam-forming apparatus for imaging applications where the x-ray source needs to be placed in close proximity to the object being imaged, while providing a large FoV significantly greater than 90 degrees.

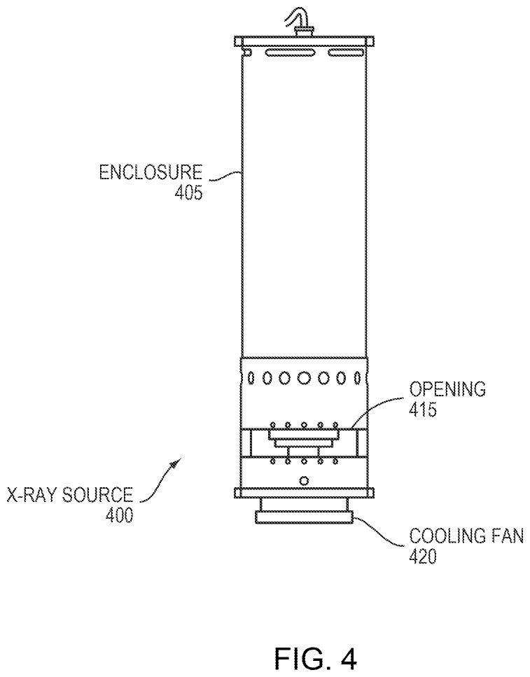

FIG. 4 illustrates an x-ray source 400 that may be implemented in example embodiments. The x-ray source 400 is a high-energy, high-power x-ray source that houses an x-ray tube along with a high-voltage power supply in a single, compact cylindrical enclosure 405. The radiation output angle of the x-ray source 400, emitted via an opening 415 may be relatively large (e.g., 40°×140°), allowing a FoV of up to 140 degrees. Further, the diameter of the enclosure may be relatively compact (e.g., 225 mm), which allows for use in low-profile applications. A cooling fan 420 at one end of the source 400 may direct air through the enclosure 405 to cool the internal x-ray tube and power supply. The x-ray source 400 may be unipolar or bipolar, such as a 320 kV, 450 kV, or 600 kV bipolar tube. An example of such an x-ray source is the Ion Series from Comet® X-ray, which is air-cooled and capable of 600 Watt operation at 300 kV.

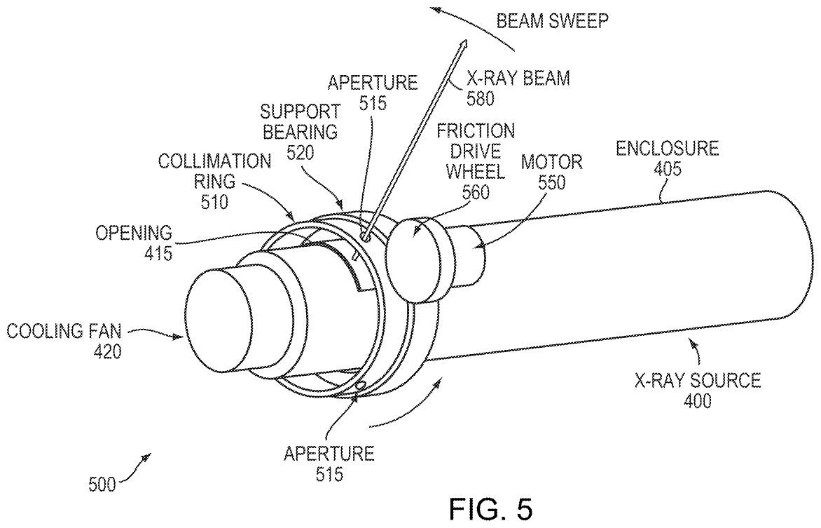

FIG. 5 illustrates a sweeping x-ray beam apparatus 500 in an example embodiment. The x-ray source 400 described above, or a comparable x-ray source, may be mounted inside a support bearing 520 (e.g., a large bore bearing) that surrounds the source enclosure 405 at or near the opening 415 emitting x-ray radiation. A collimation ring (or “collar”) 510 may be coupled to the support bearing 520 and may define one or more circular, elliptical, or square beam-forming apertures 515. The collimation ring may be coupled to the inner or outer surface of the support bearing 520 and positioned relative to the opening 415 so as to collimate the x-ray radiation emitted by the x-ray source 400. The support bearing 520 enables rotation of the collimation ring 510 around the enclosure 405, thereby moving the apertures 515 across the radiation focal point at the opening 415 to generate a sweeping x-ray beam 580. The support bearing 520 may be configured to be capable of reasonably high rotation speeds without generating excessive heat or being subject to premature bearing failure.

In one example, the x-ray source 400 may have an outer diameter near the focal spot of approximately 9 inches. The support bearing 520 may be a deep-groove bearing, such as a 9-inch bore, deep-groove ball bearing, with an outer diameter of 14.5 inches, which can rotate at speeds up to 1700 revolutions per minute (rpm) with oil lubrication. If grease lubrication is used, the bearing may be able to rotate at up to 60% of this speed, or approximately 1100 rpm.

The collimation ring 510 may include a highly attenuating material such as tungsten, or a matrix material loaded with a high atomic number material, such as tungsten, lead, or bismuth. The collimation ring 510 may be illuminated from the inside by a fan beam of x-rays emitted from the focal spot at the opening 415 of the x-ray source 400. A fan beam may be defined as a beam that is narrower along the axial direction (along the rotation axis of the ring 510) and wider along the azimuthal direction perpendicular to the axial direction. As an example, an embodiment may use a 5°×140° fan beam of radiation. The width of the fan beam in the axial direction may be configured so that the apertures 515 are fully illuminated across their width. The extent of the fan beam in the non-axial direction may be configured such that only one aperture 515 can be illuminated at any given time. The illuminated apertures 515 in the collimation ring 510 allow some of the incident x-rays to pass through it, generating the sweeping x-ray beam 580. The apertures 515 may be circular, elliptical, or rectangular, and may have a conical cross section.

A drive system including an electric motor 550 may be mounted to the support bearing 520 or another structure (not shown) to secure its position relative to the collimation ring 510, and may drive a friction drive wheel 560 adjacent to the collimation ring 510. Thus, the collimation ring 510 may be rotated on the support bearing 520 by the motor 550 via the friction drive wheel 560. Alternatively, the motor 550 can be configured to rotate the collimation ring 510 by other mechanical means, such as a gear train or a drive belt (not shown). As the collimation ring 510 rotates about the x-ray source 400, the x-ray beam 580, formed by one of the apertures 515 in the ring 510 that is illuminated by the fan beam, sweeps across an inspection area. For example, if the collimation ring 510 defines three apertures 515 and rotates at 1000 rpm, the apparatus 500 will image an object in the inspection area at a rate of 50 scan lines/second. If the apparatus 500 is used to image passing vehicles, then such a system can create images with a scan line separation of about one inch at vehicle speeds up to approximately 3 mph.

In an application benefiting from a low-profile x-ray beam generator, the apparatus 500 may be configured to be far smaller in some dimensions than prior-art systems such as those described above. For example, the collimation ring 510 may have an outer diameter less than 150%, 140%, 130% or 120% of an outer diameter of the enclosure 405 at the opening 415. Likewise, the support bearing 520 may have an outer diameter that is comparable to the outer diameter of the collimation ring 510, or if larger, may be less than 200% of the outer diameter of the enclosure 405 at the opening 415. Further, an inner surface of the collimation ring may be positioned relatively close (e.g., less than 5 centimeters) to an outer surface of the enclosure. Such a configuration also enables the apparatus to provide a wide FoV of the sweeping x-ray beam (e.g., greater than 100°, 120°, or 140°). As a result of the low-profile capability and wide FoV, example embodiments of the apparatus 500 may confer particular advantages when implemented in a near-field backscatter imaging system. For example, if such a system is configured to image objects relatively close to the apparatus 500 (e.g., within 1-1.5 meters), the apparatus 500 may provide a sweeping x-ray beam having a wide FoV to provide accurate imaging of near-field objects within a large volume adjacent to the apparatus 500.

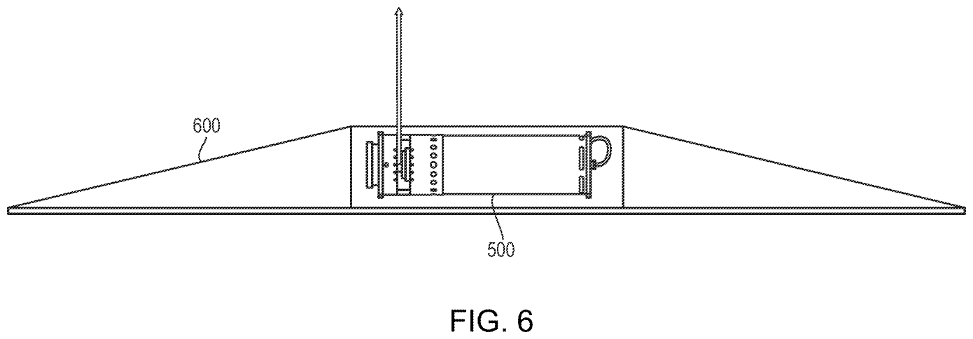

FIG. 6 illustrates a relocatable ramp 600 configured to house the apparatus 500 in one example application. Because the apparatus 500 may be a low-profile x-ray beam source, it can be mounted within the ramp 600 to form a component of a relocatable undercarriage inspection system, which employs a low-profile ramp that can be driven over by a vehicle to be inspected. Other components of the relocatable undercarriage inspection system may include radiation detectors and image processing equipment (not shown) as known in the art.

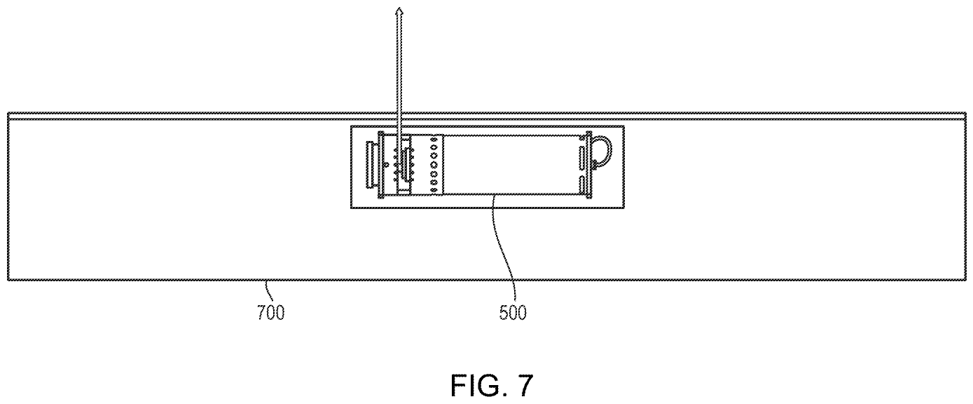

FIG. 7 illustrates a further application of the apparatus 500, which is installed within a shallow trench 700 below an environment to be illuminated by the apparatus 500. Here, the apparatus 500 may be implemented in an undercarriage inspection system comparable to the system described above, but as a permanent rather than relocatable installation. The shallow trench 700 enables an undercarriage inspection system including the apparatus 500 to be installed more easily and quickly in such a permanent installation, in contrast with a larger excavation that would be required to install larger, prior-art x-ray beam sources. As an example, a trench 700 required to install an embodiment of the apparatus 500 described above, with a 14.5 inch-diameter support bearing supporting the ring collimator, could be as few as 18 inches deep.

While example embodiments have been particularly shown and described, it will be understood by those skilled in the art that various changes in form and details may be made therein without departing from the scope of the embodiments encompassed by the appended claims.

What is claimed is:

1. An apparatus for generating a sweeping x-ray beam, the apparatus comprising:
an x-ray source configured to emit a beam of x-ray radiation through an opening in an enclosure;
a collimation ring defining at least one aperture, the collimation ring encompassing the enclosure at the opening and having an outer diameter less than 150% of an outer diameter of the enclosure at the opening;
a support bearing coupled to the collimation ring and configured to enable the collimation ring to rotate about the x-ray source; and
a drive system configured to rotate the collimation ring about the x-ray source during activation of the x-ray source to form the sweeping x-ray beam via the at least one aperture.

2. The apparatus of claim 1, wherein the support bearing has an outer diameter less than 200% of the outer diameter of the enclosure at the opening.

3. The apparatus of claim 1, wherein the drive system includes a motor configured to rotate a friction wheel coupled to a surface of the collimation ring.

4. The apparatus of claim 1, wherein the drive system includes a gear train configured to rotate the collimation ring about the x-ray source.

5. The apparatus of claim 1, wherein the drive system includes a drive belt configured to rotate the collimation ring about the x-ray source.

6. The apparatus of claim 1, wherein an inner surface of the collimation ring is positioned fewer than 5 centimeters from an outer surface of the enclosure.

7. The apparatus of claim 1, wherein a field of view of the sweeping beam of x-rays is greater than 100 degrees.

8. The apparatus of claim 1, wherein a field of view of the sweeping beam of x-rays is greater than 120 degrees.

9. The apparatus of claim 1, wherein a field of view of the sweeping beam of x-rays is greater than 140 degrees.

10. The apparatus of claim 1, wherein the x-ray source includes an x-ray tube and a high-voltage power supply incorporated within the enclosure.

11. The apparatus of claim 10, further comprising a fan configured to air-cool the x-ray source.

12. The apparatus of claim 1, wherein the x-ray source includes a unipolar x-ray tube.

13. The apparatus of claim 1, wherein the x-ray source includes a bipolar x-ray tube.

14. The apparatus of claim 1, wherein the support bearing is a deep-groove ball bearing.

15. The apparatus of claim 1, wherein the bearing is grease-lubricated.

16. The apparatus of claim 1, wherein the bearing is oil-lubricated.

17. The apparatus of claim 1, further comprising a relocatable ramp housing the x-ray source, collimation ring, support bearing, and drive system.

18. The apparatus of claim 1, wherein the apparatus is configured to be installed in a trench below an environment to be illuminated by the apparatus.
